(19) United States
(12) Patent Application Publication
(10) Pub. No.: US 2019/0082119 A1
(43) Pub. Date: Mar. 14, 2019

(54) ENCODING DEVICE COMPRISING VIDEO SWITCHING DEVICE, ENCODING METHOD INCLUDING VIDEO SWITCHING DETECTION METHOD

(71) Applicant: HITACHI KOKUSAI ELECTRIC INC., TOKYO (JP)

(72) Inventors: ATSUSHI MIYASHITA, TOKYO (JP); HIROYUKI TAKESUE, TOKYO (JP)

(21) Appl. No.: 16/084,309

(22) PCT Filed: Feb. 2, 2017
(86) PCT No.: PCT/JP2017/003753

§ 371 Date: Sep. 12, 2018

(30) Foreign Application Priority Data
Mar. 24, 2016 (JP) 2016-060413

(51) Int. Cl. H04N 5/268; H04N 19/162; H04N 19/124

(52) U.S. Cl. CPC H04N 5/268; H04N 19/124; H04N 19/162

(57) ABSTRACT

A video switching device includes a video switching unit that has at least two video signal input units, and an encoding device. The video switching unit includes a switch unit that outputs two signals as a result of changes in different states, the two signals being a pre-control signal and a camera switching signal, and a camera video switching unit that switches two video signals. The encoding device includes an encoding unit that encodes video signals, and a control unit that, by means of the pre-control signal, reduces the amount of code generated by the encoding unit.

### FIELD OF THE INVENTION

The present invention relates to an encoding device including a video switching device, and an encoding method including a video switching detection method.

### BACKGROUND OF THE INVENTION

A conventional video switching device will be described with reference to FIGS. 3 to 8.

FIG. 3 is a block diagram for explaining the conventional video switching device.

A video switching device 500 includes a video switching unit 510 and an encoding device 520.

The video switching unit 510 includes a switch unit 511 and a camera video switching unit 112. The video switching unit 510 has two input terminals for inputting video signals VID1 (Video1) and VID2 (Video2), and an output terminal for outputting a video signal SI-VID (Selected-Video).

When the switch unit 511 is pressed, the switch unit 511 outputs a high-level or low-level camera switching instruction signal SW-cnt to the camera video switching unit 112.

The camera video switching unit 112 outputs a video signal VID1 or VID2 based on the camera switching instruction signal SW-cnt. For example, the camera video switching unit 112 outputs VID1 when the low-level camera switching instruction signal SW-cnt is outputted, and the camera video switching unit 112 outputs VID2 when the high-level camera switching instruction signal SW-cnt.

The video signals VID1 and V1D2 are outputted from, e.g., cameras 101 and 102, and the like.

The encoding device 520 includes a control unit 521, an encoding unit 130, and an SG (Sync Generator) unit 140.

The control unit 521 inputs a bit rate control signal and SUM, and outputs a comp control signal and an I/P0 control signal

The I/P0 control signal outputted from the control unit 521 is a signal that changes while shifting a target range to a lower stage from an upper part of a screen for each frame. The encoding unit 130 for performing image compression includes an I (Intra-coded Picture) processing unit 131, a P (Predictive-coded. Picture) processing unit 132, a selection unit 133, a buffer memory unit 134, and a decoding unit 135.

In the encoding unit 130, the I processing unit 131 generates compressed data I-CD from the inputted video signal SI-VID; the P processing unit 132 generates compressed data P-CD from the inputted video signal SI-VID; the selection unit 133 selects the compressed data I-CD or P-CD and outputs the selected data S-CD to the buffer memory unit 134; and the buffer memory unit 134 outputs compressed data. Further, the decoding unit 135 decodes the selected data S-CD and outputs the decoded video signal V-DEM to the P processing unit 132.

FIG. 6 is a block diagram for explaining the operation of the I processing unit.

The I processing unit 131 includes a converting unit 801, a quantization unit 802, and a Huffman coding unit 803. The converting unit 801 performs, e.g., DCT (Discrete Cosine Transform) conversion on the inputted video signal SI-VID. The quantization unit 902 and the Huffman coding unit 803 create and output the compressed data I-CD.

FIG. 7 is a block diagram for explaining the operation of the P processing unit.

The P processing unit 132 includes a difference unit 904, a converting unit 801, a quantization unit 802, and a Huffman coding unit 803. The difference unit 904 obtains a difference between the video signal SI-VID of the current frame and the video signal V-DEM of the previous frames. The converting unit 801 performs, e.g., DCT (Discrete Cosine Transform) conversion, on the difference video signal. The quantization unit 802 and the Huffman coding unit 803 create and output the compressed P-CD.

In the encoding unit 130, a normal video includes a main picture having high correlation with the previous frame with the same picture as that of the previous frame partially shifted. Therefore, the difference between the previous frame image and the current frame image is obtained (referred to as “P processing”). Then, the difference is encoded and quantized to create compressed data.

The I processing is performed on a part of the video, and the P processing is performed on the other part of the video.

The ordinary video is designed to have a small difference between frames and a smaller amount of data. Particularly, a still picture is substantially the same as that of the previous frame. Therefore, in the case of the still picture, the difference is 0 and the amount of data newly generated by the P processing is substantially 0.

FIG. 4 is a timing chart for explaining the operation shown in FIG. 3.

As shown in FIG. 4, the range of the I processing is limited to a part of the video. Since the range of the I processing is shifted for each frame, the amount of data is increased, the accumulation of video errors on the decoding side is prevented.

In a normal video, a difference between frames is small, and the amount of data generated by performing the P processing P on most of the image is small.

However, depending on the circumstances of video production, the operation of switching to another camera video may be required. In that case, the correlation with the previous frame image disappears and, thus, the difference changes considerably. Accordingly, even if the P processing is performed, the amount of data to be transmitted is considerably increased. In addition, it is required to restrict the code generation amount, and the amount of generated data is reduced by performing coarse quantization and discarding fine components.

FIGS. 5A and 5B explain the amount of generated data and the image quality of similar images and different images between frames in the I processing and the P processing of images.

FIG. 5A shows the amount of data generated in the case of performing constant quantization. In the I processing, a large amount data is generated in both of similar images and different images. In the P processing, a small amount of data is generated in similar images and a large amount of data is generated in heterogeneous images.

FIG. 5B shows the image quality obtained when the amount of data, is constant. In the I processing, the image quality is poor in both of similar images and different images. In the P processing, the image quality is good in the similar images and is poor in the different images.

FIG. 8 explains an image obtained by conventional image switching

When the fine components outputted from the converting unit 501 are discarded and decoded, the error from the original image difference is increased. As a result, the image reproducibility is decreased and the image quality deteriorates. Such characteristics are shown in FIGS. 5A, 5B and 8.

In FIG. 8, the entire picture was changed in the third frame (c). Therefore, in each P processing, the changes are increased due to different images, and the amount of generated data tends to be increased. Accordingly, the amount of data is decreased by coarse quantization.

In a transition period in which the amount of generated data tends to be increased in each P processing, the amount of data that can be allocated to the I processing is decreased. Therefore, the image quality of the decoded video deteriorates and details of the entire screen are omitted.

In a prior art document, e.g., in Patent Document 1, in a video sending device having an active system and one or more standby systems, a digital video signal is distributed to the active system and the standby systems, and the amount of video data of each video frame in a decoded output of the active system is calculated by a video change detector. The active system is switched to the standby system to output the video data when it is detected that the amount of video data of each video frame is not changed.

Patent Document 1; Japanese Patent Application Publication No. 2007-43520

### SUMMARY OF THE INVENTION

An object of the present invention is to prevent image quality degradation during the switching that occurs when video signals are encoded.

In accordance with an aspect of the present invention, there is provided a video switching device including: a video switching unit having at least two video signal input units; and an encoding device, wherein the video switching unit including: a switch unit configured to output two signals depending on changes in different states, the two signals being a pre-control signal and a camera switching signal; and a camera video switching unit configured to switch two video signals, wherein the encoding device includes; an encoding unit configured to encode video signals; and a control unit configured to, by means of the pre-control signal, reduce an amount of code generated by the encoding unit.

When the camera switching signal is outputted from the switch unit, the control unit may perform control to return the amount of code generated by the encoding unit to an original amount.

In accordance with another aspect of the present invention, there is provided a video switching method including: inputting at least two video signals; reducing an amount of generated code by a pre-control signal; and switching a video signal outputted by a camera switching signal.

The video switching method may further include returning the amount of generated code to an original amount when the camera switching signal is outputted.

### Effect of the Invention

In accordance with the present invention, it is possible to prevent the image quality degradation during the switching that occurs when video signals are encoded. More specifically, the image quality degradation during the switching that occurs when the video signals are encoded can be prevented by previously reducing the amount of code generated by the encoding unit and dealing with the amount of code which is increased by a new video to be switched.

### BRIEF DESCRIPTION OF THE DRAWINGS

FIG. 1 is a block diagram for explaining a video switching apparatus according to an embodiment of the present invention.

FIGS. 2A and 2B are a timing chart for explaining the operation shown in FIG. 1.

FIG. 3 is a block diagram for explaining a conventional video switching device.

FIG. 4 is a timing chart for explaining the operation shown in FIG. 3.

FIGS. 5A and 5B explain the amount of generated data and the image quality of similar images and different images in I processing and P processing of images.

FIG. 6 is a block diagram for explaining the operation of the I processing unit.

FIG. 7 is a block diagram for explaining the operation of the P processing unit.

FIG. 8 explains an image obtained by conventional image switching.

### DETAILED DESCRIPTION OF THE EMBODIMENTS

Hereinafter, embodiments of the present invention will be described in detail with reference to the drawings.

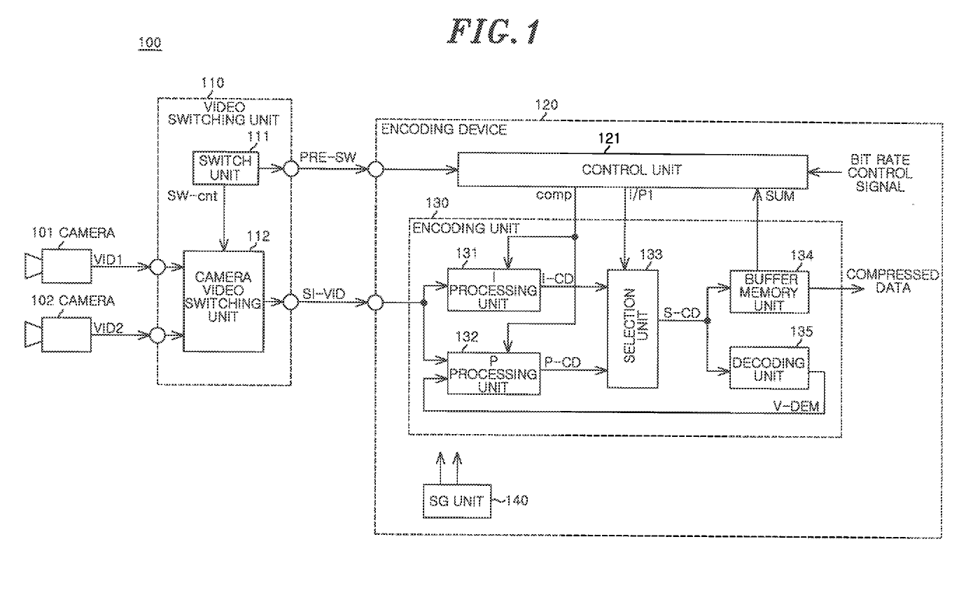

FIG. 1 is a block diagram for explaining a video switching device according to an embodiment of the present invention.

In FIG. 1, a video switching device 100 includes a video switching unit 110 and an encoding device 120.

The video switching unit 110 includes a switch unit 111 and a camera video switching unit 112. The video switching unit 100 has two input terminals for inputting video signals VID1 (Video1) and VID2 (Video2), an output terminal for outputting a video signal SI-VID (Selected-Video), and an output terminal for outputting a pre-control signal PRE-SW.

The video signals VID1 and VID2 are outputted from cameras 101 and 102, or the like.

The switch unit 111 outputs two signals depending on a pressed depth.

When the switch unit 111 is pressed to a small depth, the pre-control signal PRE-SW is outputted. When the switching unit 111 is pressed to a large depth the camera switching instruction signal SW-cnt is outputted.

The switch unit 111 may output two signals depending on a difference in a pressing pressure such as 3D (Three Dimensions) touch.

Further, instead of distinguishing the pressed depth of the switch unit 111, by setting pressing the switch unit 111 the case where the pressed depth is small and releasing the switch unit 111 to the case where the pressed depth is large, it is possible to realize the same control as that in the case of detecting the state in which the pressed depth of the switch unit 111 is small and the state in which the pressed depth of the switch unit 111 is large based on a period of time in which the switch unit 111 is pressed. By performing control based on the changes in different states of the switch unit 111, the same control can be realized by a conventional touch panel or the like. The same control can also be realized by the number of taps on the touch panel or the slide operation of the touch position.

The camera video switching unit 112 outputs a video signal of VID1 or VID2 based on the video switching signal SW-cnt. For example, the camera video switching unit 112 outputs VID1 when the camera switching instruction signal SW-cnt of a low-level is outputted, and the camera video switching unit 112 outputs V1D2 when the camera switching instruction signal SW-cnt of a high-level is outputted.

The encoding device 120 includes a control unit 121, an encoding unit 130, and an SG (Sync Generator) unit 140.

The control unit 121 inputs the pre-control signal PRE-SW, a bit rate control signal and SUM, and outputs a comp control signal and an I/P1 control signal.

In addition, the control unit 121 may input the camera switching instruction signal SW-cnt.

The encoding unit 130 for performing image compression includes an I (Intra-coded Picture) processing unit 131, a P (Predictive-coded Picture) processing unit 132, a selection unit 133, a buffer memory unit 134, and a decoding unit 135.

The SG unit 140 supplies synchronization signals to the encoding unit 120 and the video switching unit 110.

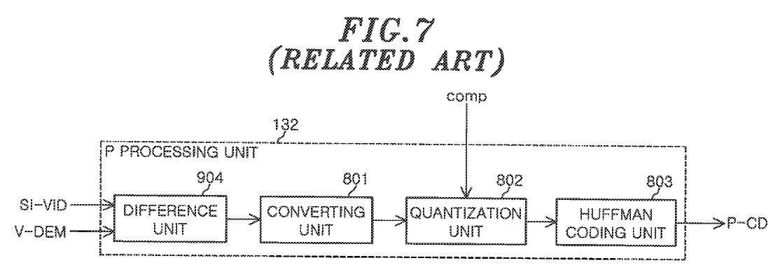

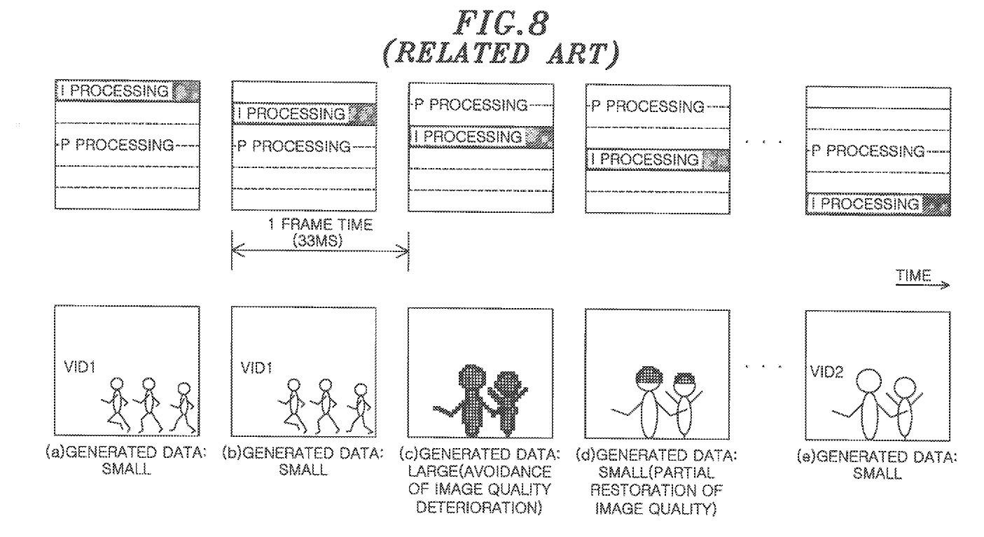

The description on the operation of the I processing unit 131 and the P processing unit 132 will be omitted because it has been described with reference to FIGS. 6 and 7.

In the encoding unit 130, the I processing unit 131 generates compressed data I-CD from the inputted video signal SI-VID; the P processing unit 132 generates compressed data P-CD from the inputted video signal SI-VID; the selection unit 133 selects the compressed data I-CD or P-CD and outputs the selected data S-CD to the buffer memory unit 134; and the buffer memory unit 134 outputs compressed data. Further, the decoding unit 135 decodes the selected data S-CD and outputs the decoded video signal V-DEM to the P processing unit 132.

The comp control signal (encoding target) outputted from the control unit 121 is a control signal for increasing or decreasing the amount of code generated by the I processing and the P processing. The I processing unit and the P processing unit increases or decreases the amount of generated code by changing the degree of quantization.

Further, based on the I/P1 control signal outputted from the control unit 121, it is selected whether a control signal to the selection unit 133 is a code according to the I processing or a code according to the P processing. When there are 1280 scanning lines to be selected sequentially from the top of the screen, the 1st to 64th scanning lines are selected for the first frame, the 65th to 128th scanning lines are selected for the second frame, and so on.

The SUM inputted to the control unit 121 is a signal related to the amount of compressed data stored in the buffer memory unit 134.

The control unit 121 controls the degree of quantization, i.e., the amount of newly generated data, by the comp control signal (encoding target) while considering the amount of SUM.

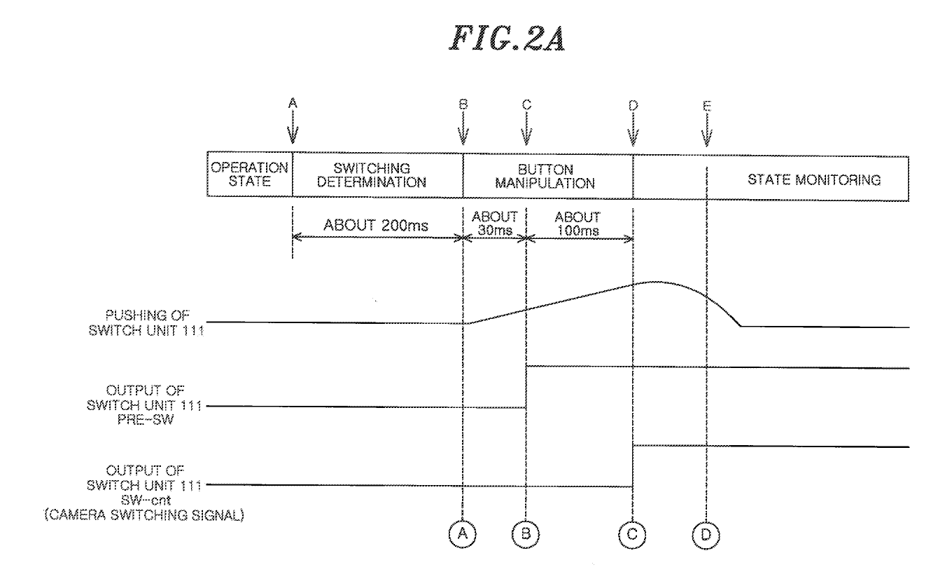

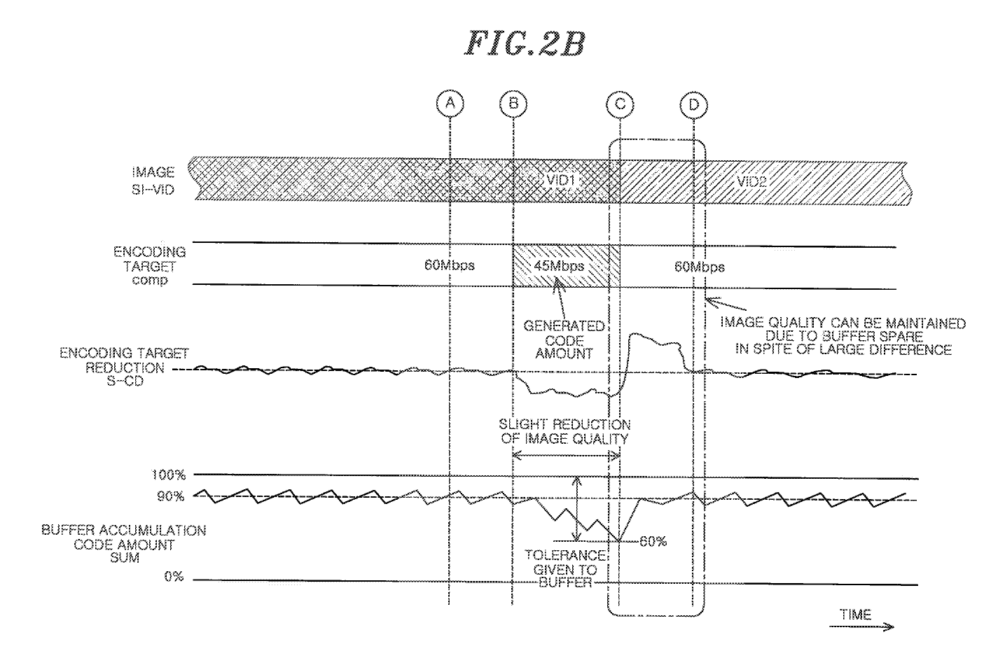

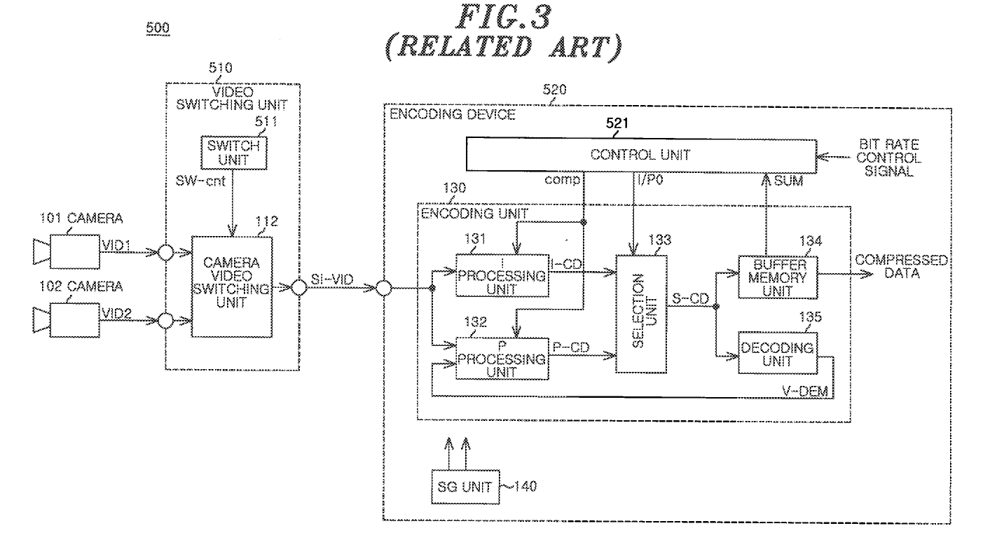

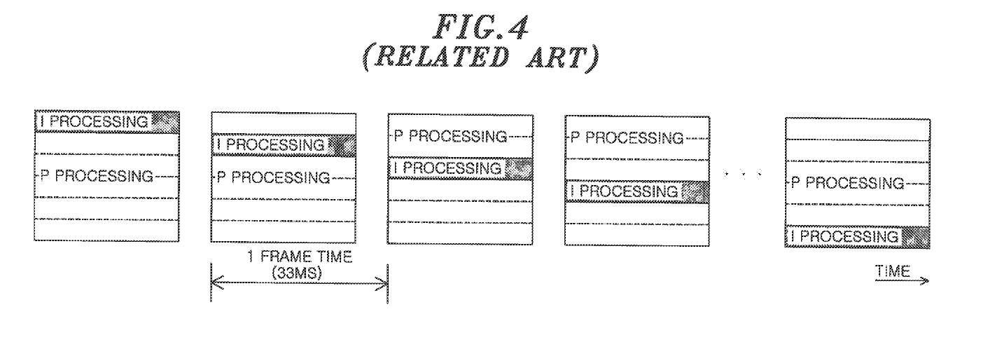

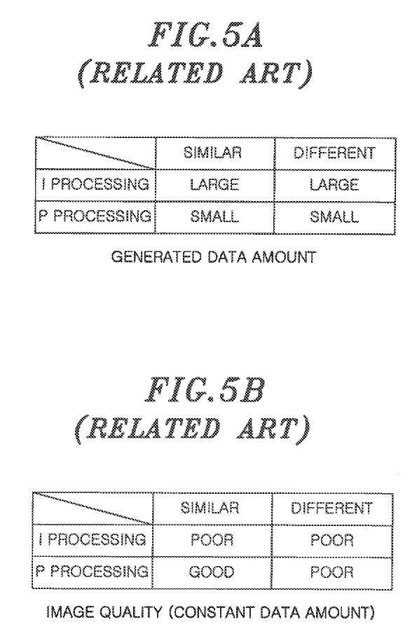

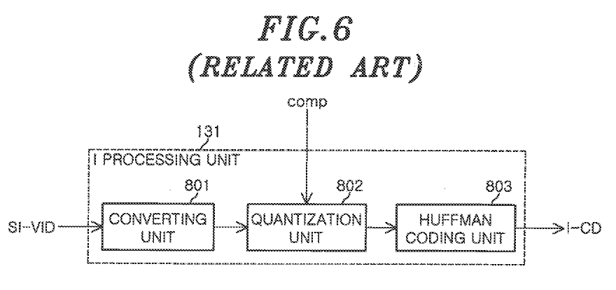

FIGS. 2A and 2B are a timing chart for explaining the operation shown in FIG. 1.

In FIGS. 2A and 2B, when the change in state is detected by the image monitoring of the video signal VID1 at time A, an operator of the camera video switching unit 112 determines switching to the video signal VID2 in about 200 ms and presses the switch unit 111 at time B.

When the switch unit 111 is pressed, the pre-control signal PRE-SW transited from a low level to a high level is outputted to the control unit 121 of the encoding device 120 at time C, e.g., after about 30 ms.

The control unit 121 of the encoding device 120 sets the encoding target comp to 45 Mbps and decreases generated code amount S-CD by setting the degree of the quantization to an intermediate level to obtain 45 Mbps. Accordingly, the image quality of the video signal VID1 slightly deteriorates.

The buffer storage code amount SUM starts to be decreased gradually. The amount of decrease is limited to an allowable lower limit (e.g., 60%).

When the switch unit 111 is pressed further, the camera switching instruction signal SW-cnt transited from a low level to a high level is outputted to the camera video switching unit 112 at time D, e.g., after about 100 ms.

The camera video switching unit 112 switches the video signal SI-VID to be outputted from the video signal VID1 to the video signal VID2.

The control unit 121 returns the encoding target comp from 45 Mbps to 60 Mbps at the time D.

In the selection unit 133, a selection ratio of the I processing is considerably increased because the video is considerably different from the previous frame at the time D.

Accordingly, the generated code amount S-CD outputted from the selection unit 133 is also increased, Since, however, the buffer storage code amount SUM is already decreased, it is not necessary to extremely reduce the generated code amount S-CD stored in the buffer memory unit 134.

Even if the encoding target comp temporarily exceeds 60 Mbps, it is sufficient to obtain the buffer accumulation code amount SUM by performing intermediate-level quantization.

As a result, the image quality of the video signal VID2 can be maintained.

At time E, the buffer storage code amount SUM of the buffer memory unit 134 reaches a predetermined amount. The control unit 121 is notified of the buffer storage code amount SUM and returns the quantization to an ordinary operation to suppress the generated code amount S-CD.

The video switching apparatus according to the embodiment of the present invention can prevent image quality degradation during the switching that occurs when video signals are encoded. Particularly, it is possible to prevent image quality degradation during the switching that occurs when the video signals are encoded by previously reducing, the amount of code generated by the encoding unit and dealing with the amount of code which is increased by a new video to be switched.

Although one embodiment of the present invention has been described in detail above, the present invention is not limited to the above-described embodiment, and various modifications can be made without departing from the spirit of the present invention.

The case of switching two cameras has been described in detail in the embodiment of the present invention. However, the same effect can also be obtained by a switching device for switching three or more cameras. The switching in that case may be performed as many as the number of switching routes).

Although it is assumed that the I processing unit 131 includes the quantization unit 802 and the Huffman coding unit 803, it is also possible to provide the quantization processing or the Huffman processing at a rear stage of the selection unit 133. Further, the P processing unit may have the same configuration as that described above.

This application claims priority to Japanese Patent Application No. 2016-060413 filed on Mar. 24, 2016, the entire contents of which are incorporated herein by reference.

### INDUSTRIAL APPLICABILITY

By reducing the encoding target before the switching of the video signal, the buffer memory unit may have a spare capacity and, thus, the image quality degradation during the switching that occurs when the video signals are encoded can be prevented.

### DESCRIPTION OF REFERENCE NUMERALS

100, 500: video switching apparatus

101, 102: camera

110, 510: video switching unit

111, 511: switch unit

112: camera video switching unit

120, 320, 520: encoding device

121, 321, 521: control unit

130: encoding unit

131: I processing unit

132: P processing unit

133: selection unit

134: buffer memory unit

135: decoding unit

140: SG unit

801: converting unit

802: quantization unit

803: Huffman coding unit

904: difference unit

1. A video switching device comprising:
a video switching unit having video signal input units to which video signals from at least two cameras are inputted; and
an encoding device configured to encode video signals from the video switching unit,
wherein the video switching unit including:
a switch unit configured to output one of two signals depending on changes in different states, the two signals being a pre-control signal and a camera switching signal; and
a camera video switching unit configured to switch and output video signals inputted through the video signal input units based on a camera switching signal when the camera switching signal is outputted from the switch unit,
wherein the encoding device includes:
an encoding unit configured to encode video signals outputted from the camera video switching unit; and
a control unit configured to, by means of the pre-control signal outputted from the switch unit, reduce an amount of code generated by the encoding unit, and
wherein in the changes in different states of the switch unit the switch unit changes from a state in which the pre-control signal is outputted to a state in which the camera switching signal is outputted.

2. The video switching device according to claim 1, wherein when the camera switching signal is outputted from the switch unit, the control unit performs control to return the reduced amount of code generated by the encoding unit to an original amount.

3. A video switching method comprising:
inputting video signals from at least two cameras;
outputting one of the inputted video signals;
encoding the outputted video signal;
setting a switch to a first state;
outputting a pre-control signal based on the first state of the switch;
reducing an amount of generated code in the encoding by the pre-control signal;
setting the switch from the first state to a second state;
outputting a camera switching signal based on the second state of the switch; and
switching a video signal outputted by the camera switching signal.

4. The video switching method of claim 3, further comprising:
returning the reduced amount of generated code in the encoding to an original amount when the camera switching signal is outputted.
